(19) United States
(12) Patent Application Publication
(10) Pub. No.: US 2021/0307498 A1
(43) Pub. Date: Oct. 7, 2021

(54) SYSTEM AND METHOD FOR CREATING CUSTOMIZED BRUSHES

(71) Applicant: MIXCREATIVE LLC, NEW YORK, NY (US)

(72) Inventor: CHRIS TARLING, BROOKLYN, NY (US)

(73) Assignee: MIXCREATIVE LLC, NEW YORK, NY (US)

(21) Appl. No.: 17/049,474

(22) PCT Filed: May 24, 2019
(86) PCT No.: PCT/US19/33931

§ 371 Date: Oct. 21, 2020

Related U.S. Application Data
(60) Provisional application No. 62/675,965, filed on May 24, 2018.

(51) Int. Cl. A46B 9/02; A45D 34/04; A45D 40/26; A46D 9/02; G06Q 30/06; G06T 7/00

(52) U.S. Cl. CPC A46B 9/021; A45D 34/042; G06T 7/97; A46D 9/02; G06Q 30/0621; A45D 40/262

(57) ABSTRACT

A method for creating and selecting customized cosmetic brushes includes utilizing a mobile application to take photos of a customer's eyelashes which are then analyzed using AI and photo analysis. This data creates a lash profile, with key attributes of spacing, length, thickness, which is turned into a custom cut makeup applicator. Through use of ascertaining and selection steps the applicator is then assembled and customized to that consumer.

### CROSS-REFERENCE TO RELATED APPLICATIONS

This application in a national stage of International Patent Application No. PCT/US2019/033931 filed on May 24, 2019, which claims the benefit of U.S. Provisional Application Ser. No. 62/675,965, filed on May 24, 2018, which are hereby incorporated by reference herein in their entireties.

### FIELD OF THE INVENTION

The present invention relates generally to brushes and, more particularly, to a system and method for creating customized cosmetic brushes.

### BACKGROUND OF THE INVENTION

Cosmetic brushes, depending on their intended use, require different shapes and styles in order to provide optimum application of product. To obtain the desired shape, most brushes are assembled first, and then the bristles are shaped. The shaping of the bristles is accomplished by a number of methods such as, for example, mechanical cutting or grinding. Existing brushes are typically mass produced and come in a limited number of sizes, shapes and bristle configurations. Typically, consumers themselves, or on recommendation from beauty consultants, will select cosmetic brushes (e.g., mascara brushes) and cosmetic products (e.g., mascara formulations) based on a desired look to be achieved, or by attempting to match the eyelash characteristics of the consumer with one of a number of limited brush sizes, shapes and bristle configurations.

A number of recent efforts have been made to more specifically tailor or personalize cosmetic products, such as mascara and/or mascara brushes, to the individual consumer. For example, one known method involves a beauty consultant visually identifying particular features of a consumer, such as lash type, and manually inputting this information into a database. The database then matches the identified lash type with one of a plurality of prestored brush shapes which suits that particular consumer. While this method is an improvement over prior processes which rely entirely on a consumer or beauty consultant, it still relies on a beauty consultant to make initial determinations of characteristics of the particular consumer, such as the shape of a consumer's eyelashes. In addition, the amount of data that a beauty consultant can collect about a consumer's eyelashes from a visual inspection is fairly limited and imprecise.

Other methods aimed at customizing cosmetic products to individual consumers involve using a computer and display to simulate the appearance of eyelashes based on the use of various mascara brushes or mascara products so that a consumer can select specific products that purport to achieve a desired look. Notably, however, such methods typically do not consider the specific eyelash characteristics of a consumer and, as such, actual results may vary from what was shown on the simulation display screen.

While existing cosmetic brushes produced by known means are generally suitable for what is regarded as ordinary performance, there is a need for a system and method of creating customized brushes, such as cosmetic brushes, that are specifically tailored to the characteristics and preferences of each individual consumer.

### SUMMARY OF THE INVENTION

It is an object of the present invention to provide a brush.

It is another object of the present invention to provide a cosmetic brush having a customized bristle configuration.

It is another object of the present invention to provide a method of manufacturing a cosmetic brush having a customized bristle configuration.

These and other objectives of the present invention, and their preferred embodiments, shall become clear by consideration of the specification, claims and drawings taken as a whole.

According to an embodiment of the invention, a method of manufacturing a custom cosmetic brush includes obtaining at least one image of eyelashes of a user, automatically determining at least one parameter of the eyelashes from the at least one image, and producing a cosmetic brush in dependence upon the at least one parameter.

According to another embodiment of the invention, a system for creating a custom cosmetic brush includes a digital imaging device configured to capture an image of eyelashes of a user, and an image analysis module configured to determine at least one parameter of the eyelashes from the image.

According to yet another embodiment of the invention, a method for customizing a cosmetic product includes generating a prompt to capture an image of eyelashes of a user, receiving a captured image of the eyelashes, determining eyelash parameter data from the captured image, and presenting a cosmetic brush recommendation to a user, or manufacturing a cosmetic brush in dependence upon the eyelash parameter data.

### BRIEF DESCRIPTION OF THE DRAWINGS

The present invention will be better understood from reading the following description of non-limiting embodiments, with reference to the attached drawings, wherein below:

FIG. 1 is a flow chart showing a cosmetic applicator customization system according to an embodiment of the present invention.

FIG. 2 is a flow chart showing a method of determining an eyelash profile of a customer, for use in the system of FIG. 1.

FIG. 3 is a diagram showing the determination of an eyelash profile shape from an image of a consumer's eyelashes, for use by the system and method of FIGS. 1 and 2.

FIG. 4 is a diagram showing the determination of eyelash characteristics from an image of a consumer's eyelashes, for use by the system and method of FIGS. 1 and 2.

FIGS. 5-16 are illustrations of a mobile application for the custom selection of a mascara brush, according to an embodiment of the invention.

### DETAILED DESCRIPTION OF THE PREFERRED EMBODIMENT

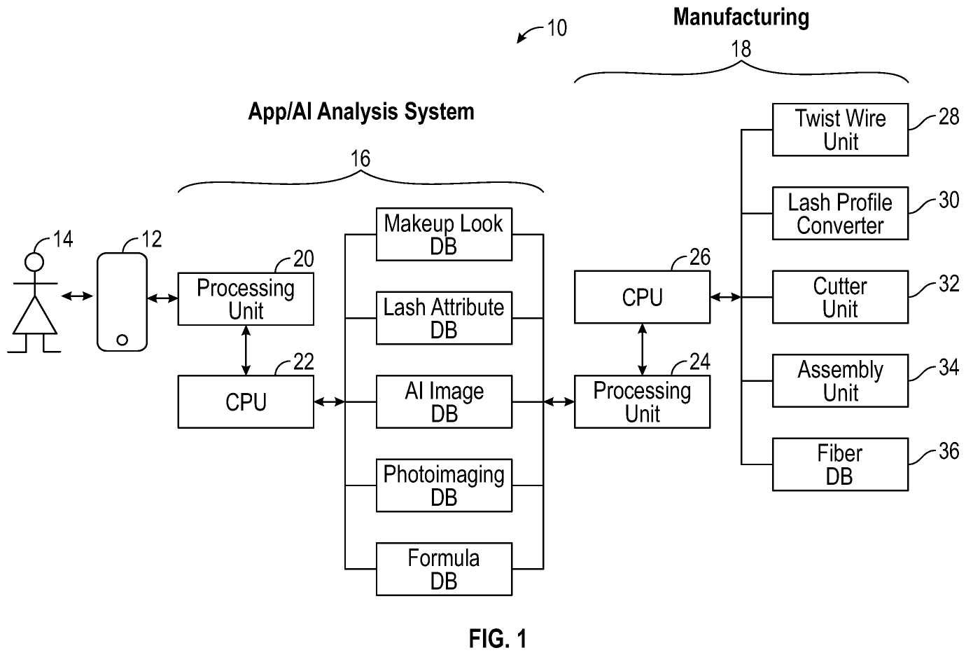

With reference to FIG. 1 a system 10 for creating customized brushes according to an embodiment of the present invention is illustrated. The system includes a digital imaging device 12 configured to capture images or photographs of, for example, the eyes and/or eyelashes of a consumer 14 using a camera integrated with the digital imaging device, a system or device 16 configured to analyze the images captured by the digital imaging device 12 and to extract information from the images, and a manufacturing system or device 18 for manufacturing or customizing a brush, e.g., a mascara brush, from the extracted information. The digital imaging device 12 may be, for example, a smartphone, tablet or computer capable of running a mobile software application, as discussed below. The digital imaging device 12 is communicatively coupled with the image analysis system 16, and the image analysis system 16 is communicatively coupled with the manufacturing system 18. Communication may be via any means known in the art, such as wired or wireless (e.g., Bluetooth, WiFi and/or over the Internet).

In an embodiment, the image analysis system 16 is integrated with the digital imaging device 12 and may be, for example, part of the mobile application software or program running on the digital imaging device 12. In other embodiments, the image analysis system 16 may be a separate system remote from the digital imaging device 12.

With further reference to FIG. 1, the image analysis system 16 may include a processing unit 20 and a controller 22, and the manufacturing system 18 may likewise include a processing unit 24 and a controller 26. In an embodiment, the manufacturing system 18 is configured to produce twisted wire and/or stacked-disc brushes and may include a device for twisting wire module 28, a lash profile converter 30, a cutter module 32, an assembly unit 34, and a fiber module 36 having an integrated database.

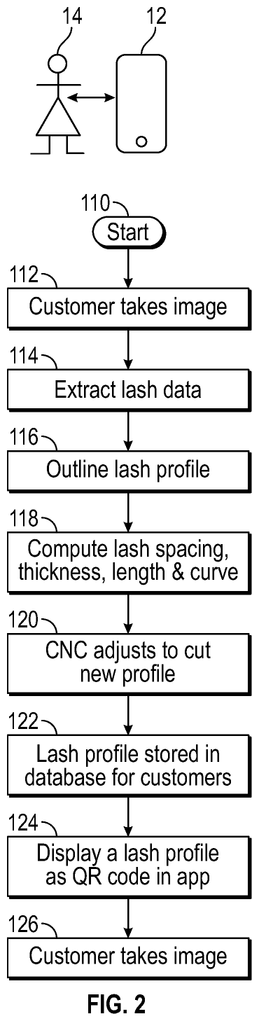

Turning now to FIG. 2, a flowchart illustrating operation of the system 10 to produce customized mascara brushes according to an embodiment of the present invention is illustrated. As shown therein, upon opening the mobile application or program on the digital imaging device 12, a user may commence the process by pressing a ‘START’ button, at step 110. The digital imaging device 12 then prompts the user to take one or more images of a user's eye's/eyelashes, at step 112. The processing unit 20 of the image analysis system 16 then extracts eyelash characteristics and/or data from the images, at step 114, and outlines a lash profile, at step 116. From the images, the system 16 also calculates or determines a number of eyelash specifications, at step 118. The characteristics or specifications may include, for example, eyelash spacing, eyelash thickness, eyelash length, and eyelash curve, although other parameters of a user's eyes, eyelashes and/or facial features may also be determined by the system 16. At step 120, the manufacturing system 18, following a preprogrammed set of instructions, then produces a customized mascara brush in dependence upon the calculated characteristics or specifications.

As indicated above, the manufacturing system 18 may be configured to produce a cosmetic brush from scratch, or may simply cut the bristles (in the case of a twisted wire or fiber brush) or discs (in the case of a stacked-disc brush) of a brush in dependence upon the eyelash characteristic data acquired from the images. In an embodiment, cutting the bristles or discs may be carried out utilizing mechanical cutting, grinding, or lasers. In yet other embodiments, the brush may additionally, or alternatively, be formed or shapes such as by bending or deforming the core section of the brush.

As further shown in FIG. 2, in an embodiment, the system 10 may store the lash profile of a particular consumer in a database, at step 122, and display a lash profile as a barcode, QR code or the like in an app for use in subsequent purchases, at step 124. At step 126, customers may again commence the customization program.

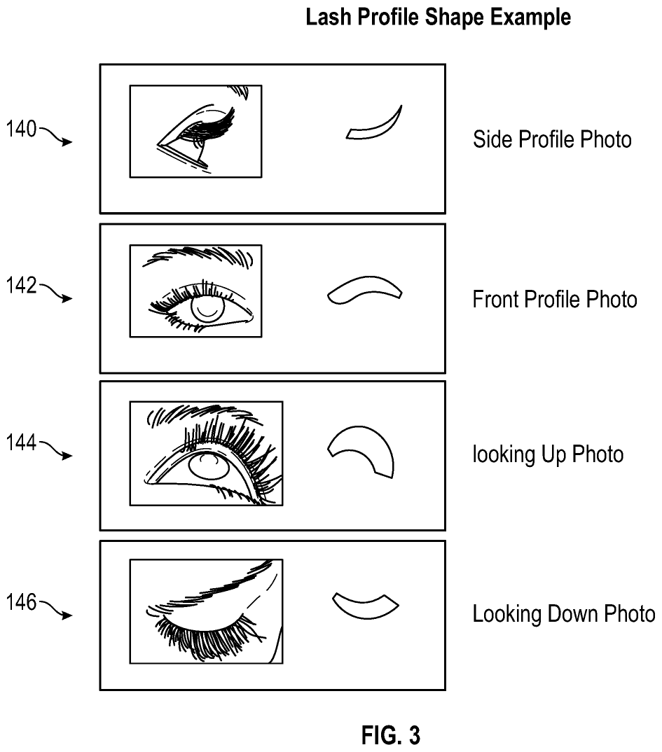

As indicated above, the digital imaging device 12, running the mobile application or software program, may prompt the user, at step 112, to take a plurality of photographs of his/her eyes and/or eyelashes using the camera of the digital imaging device 12. As illustrated in FIG. 3, in an embodiment, the digital imaging device 12 may prompt a user to capture images including a side profile photo 140, a front profile photo 142, a photo 144 looking up, and a photo 146 looking down. It is contemplated that the mobile application or program running on the digital imaging device 12 may prompt a user to take any number of photographs sufficient for the calculation of a variety of eyelash characteristics of a user. In an embodiment, the program may prompt a user to move the camera in a circle relative to a user's eye while holding his/her head steady, or to move his/her head steady while moving the camera in a circle, in order to capture the eye and/or eyelashes of a user from all reference points (i.e., 360 degrees). In yet other embodiment, it is contemplated that a video of a user's eyes/eyelashes may be captured by the digital imaging device 12 and utilized by the system 16 to extract eyelash data.

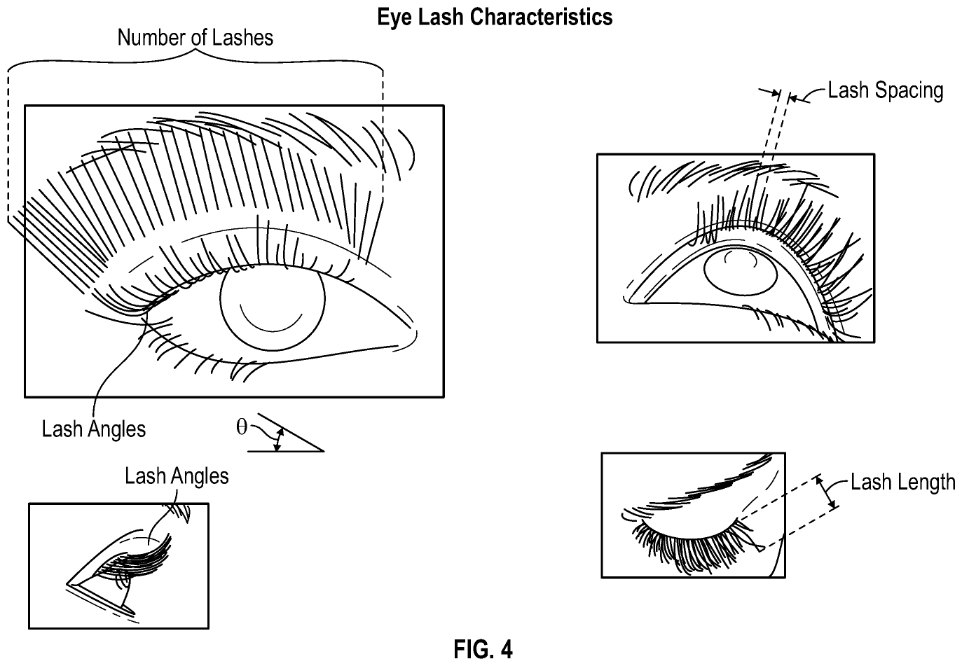

As disclosed above, it is contemplated that the system 16 may calculate a plurality of eyelash characteristics/specifications from the images. With reference to FIG. 4, these characteristics may include, for example, a number of eyelashes of a user, eyelash spacing, eyelash length and/or eyelash angle. Eyelash spacing may be an average spacing between the eyelashes of a user. In other embodiments, eyelash spacing may be a median eyelash spacing, a smallest eyelash spacing, or a largest eyelash spacing. Eyelash length may be determined in a similar manner. It is further envisioned that eyelash spacing and length may be determined for each individual eyelash, enabling for customization of a mascara brush to an extent heretofore not seen in the art.

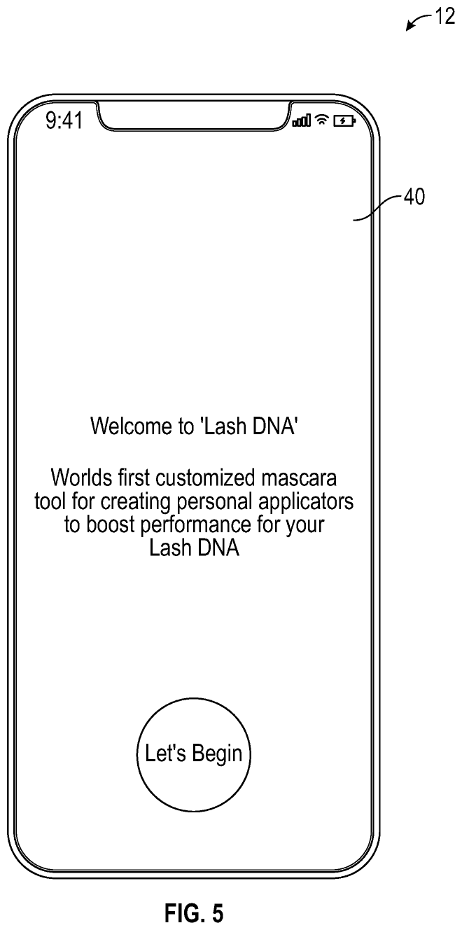

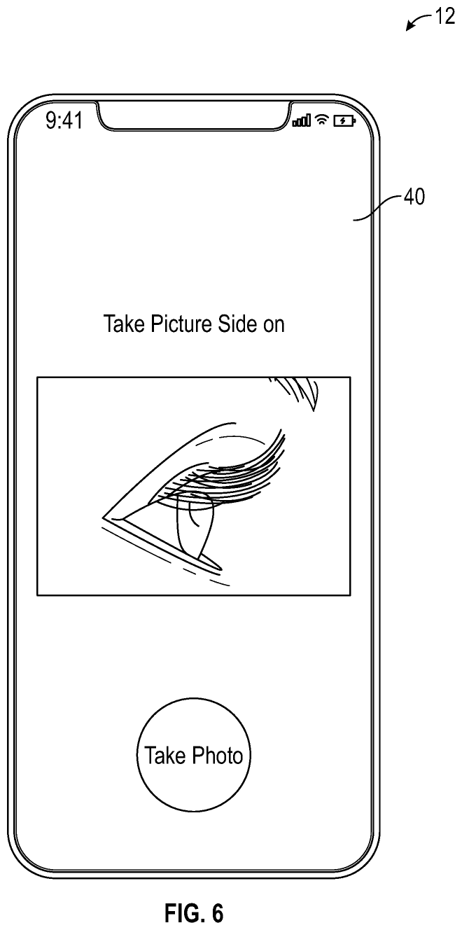

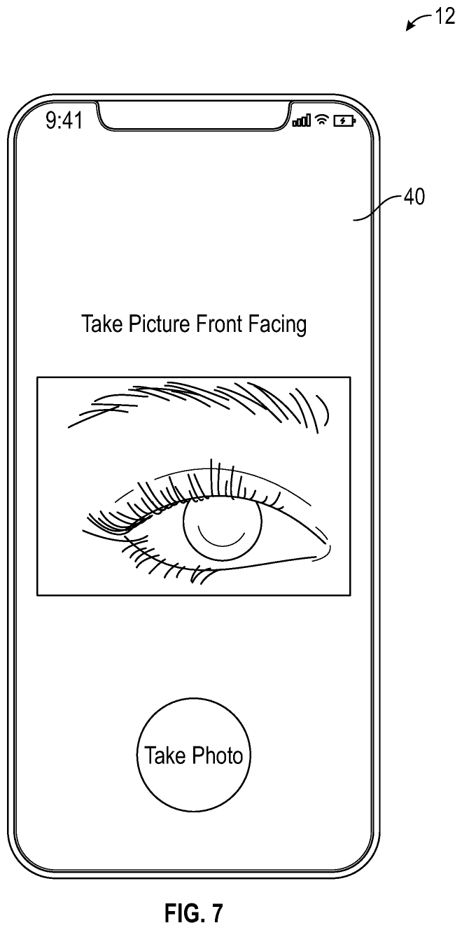

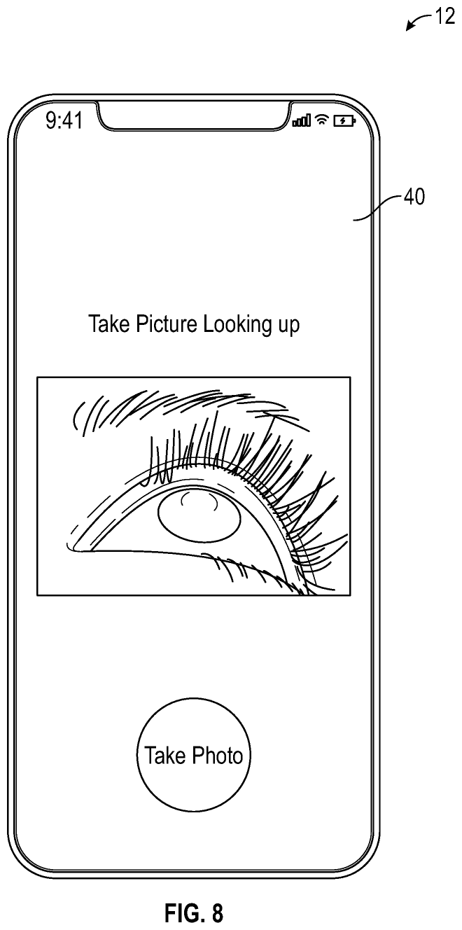

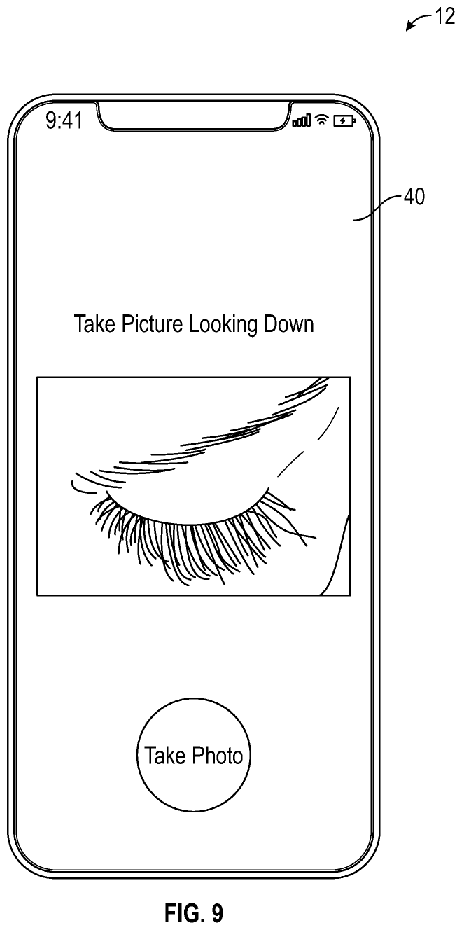

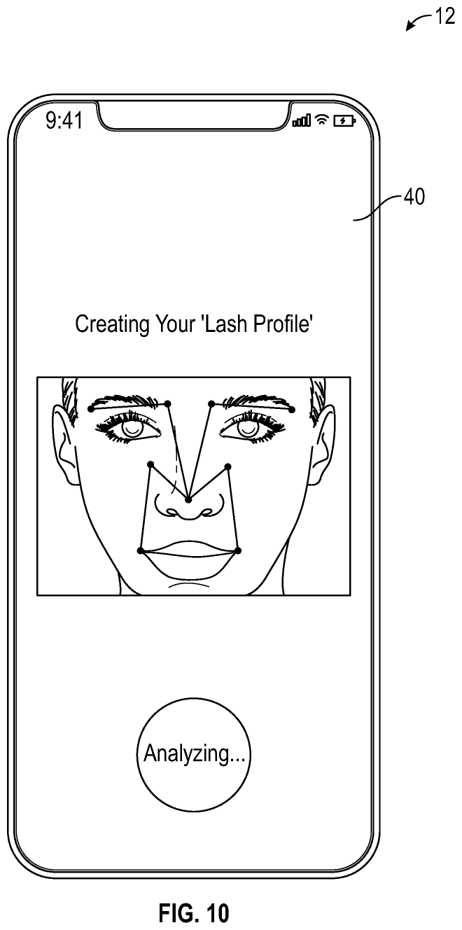

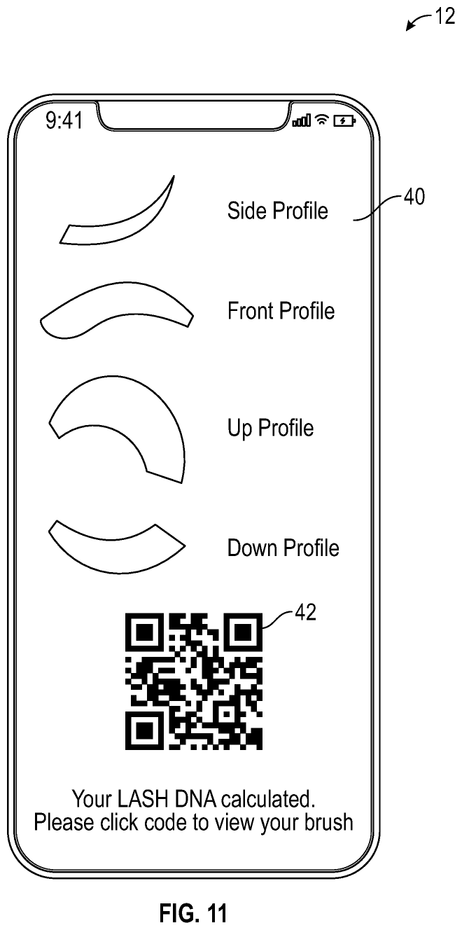

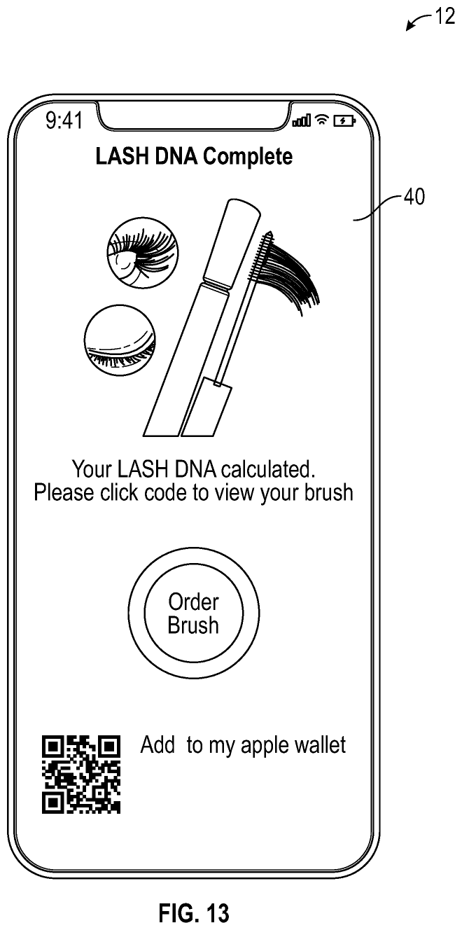

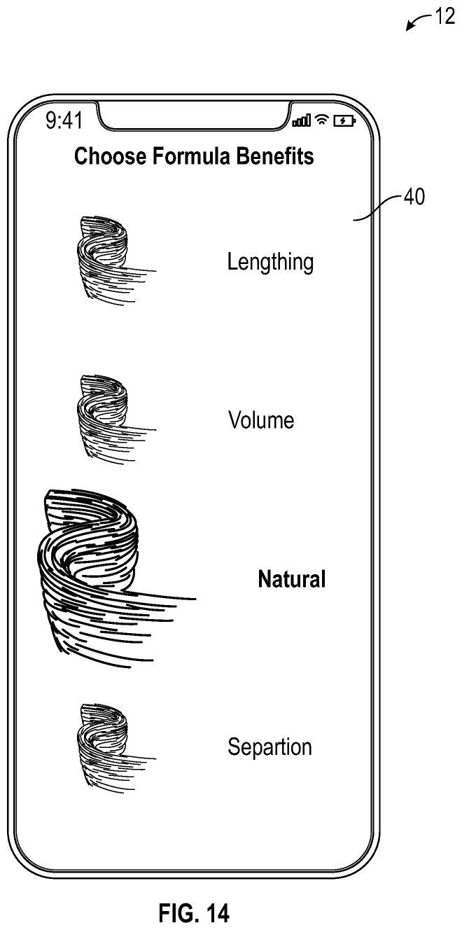

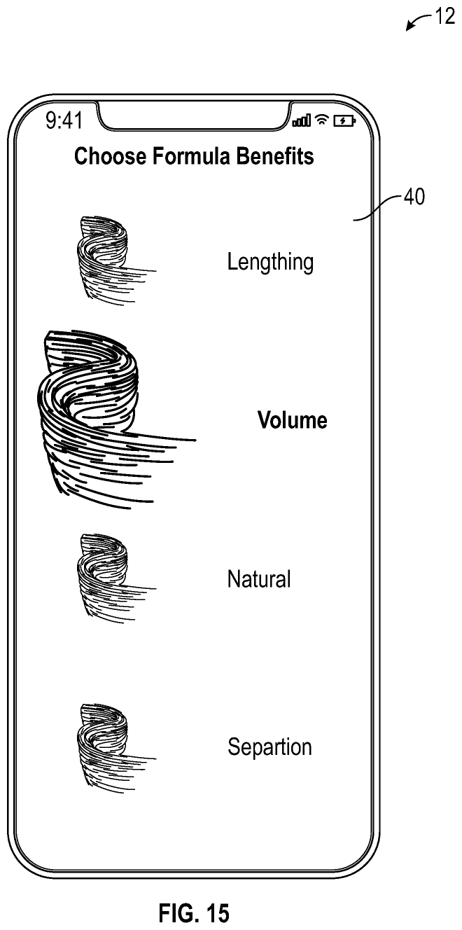

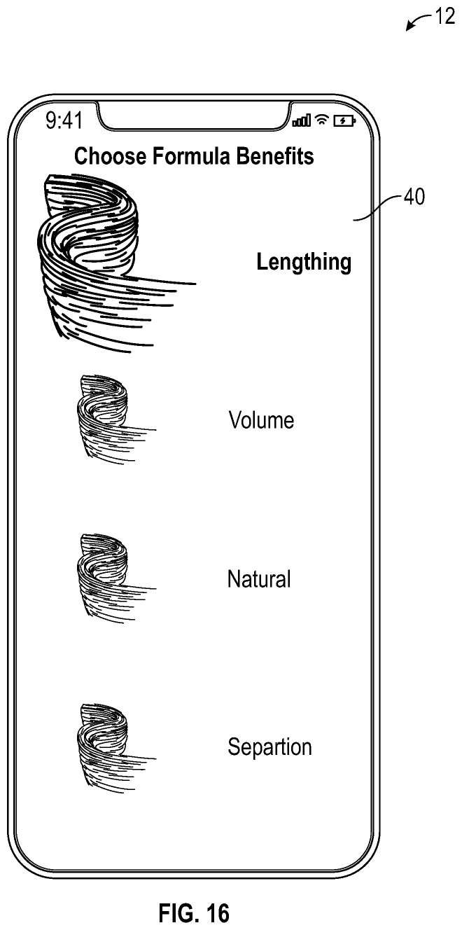

FIGS. 5-16 illustrate one possible implementation of the mobile application or program on the display screen 40 of the digital imaging device, for use in capturing images to be later used by the system 10. As shown in FIG. 5, a start screen is displayed upon opening of the application on the digital imaging device. As illustrated in FIGS. 6-9, the mobile application on the digital imaging device 12 then prompts the user to take a picture from the side, front facing, looking up, and looking down. As shown in FIGS. 10 and 11, in this embodiment, the digital imaging device 12, via the mobile application, analyzes the images to create an eyelash profile. In an embodiment, the application may then recommend an existing, commercially available brush in dependence upon the eyelash characteristic data acquired or derived from the images, and may display a barcode, QR code 42 or other product identifying information so that a user can purchase or order the brush. Alternatively, in some embodiments, the eyelash characteristic data may be utilized to create a fully customized or personalized brush either in store or for shipment to a customer.

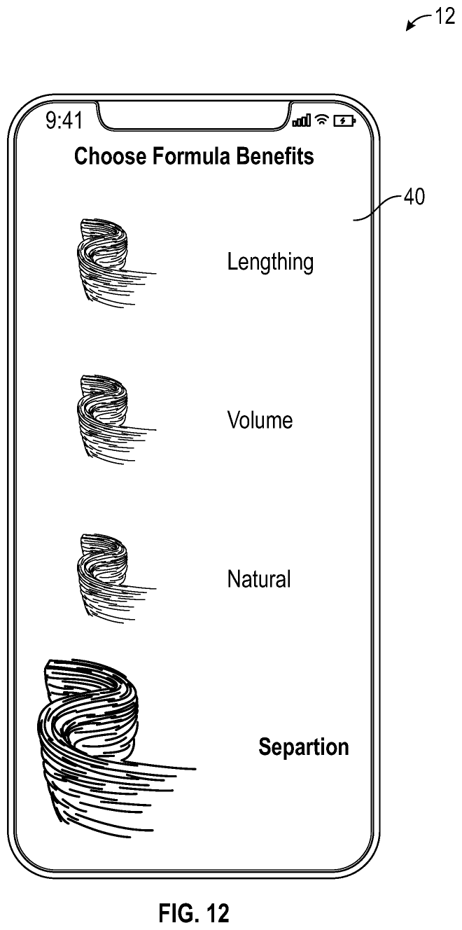

With reference to FIGS. 12-16, in an embodiment, in addition to creating customized mascara brushes, the system 10 of the invention may additionally be utilized to select for a user a customized mascara formula. In particular, after acquiring the data needed to manufacture or recommend a customized mascara brush, the mobile application/program on the digital imaging device may ask a user to select what benefit(s) they would like from the mascara formula, e.g., lengthening, volume, a natural look, and/or separation. The digital imaging device 12 may then display a button for ordering the cosmetic product, either on a one time or subscription basis. In this manner, the present invention contemplates that a mascara product (e.g., a brush, alone, a mascara formula, alone, or a mascara brush and mascara formula kit) may easily be customized and ordered from a user's digital imaging device (i.e., a smartphone or tablet).

The present invention therefore provides a system and method for creating custom cosmetic brushes based on a photograph of a user's eyelashes. In particular, as discussed above, the image analysis system or module 16 automatically determines eyelash characteristic data from the captured images, at a level of precision heretofore not seen in the art. As used herein, “automatically” means without eyelash analysis being carried out by a human (e.g., by a computer, alone). This manufacturing system 18 may then custom cut the bristles or discs of the brush in dependence upon the precise eyelash characteristic data acquired.

That is, the present invention provides a system and method of manufacturing and/or selecting a specific cosmetic application bristle shape in dependence upon the particular eyelash data of a consumer, which can take the form of a mobile application running on, for example, a consumer's smartphone or computer. As discussed above, a consumer using the application is prompted to take images of his/her eyelashes and/or face. These images are then analyzed using AI photo analysis to extract data that is then used to create an eyelash profile for that specific user. The eyelash profile may include information relating to eyelash spacing, length, thickness or other parameters, which is then utilized to manufacture a custom cut cosmetic (e.g., mascara) applicator.

Through the use of eyelash data acquisition and selection steps, a cosmetic applicator may then be assembled and the bristles thereof cut to the specific eyelash configuration of a customer. In an embodiment, the stored eyelash data can also allow customers to re-order or subscribe on a timely basis to new or matching makeup effects. Moreover, it is contemplated that the manufacturing system 18 may deployed in commercial cosmetic stores, so that user's can capture images of their eyelashes and the system 18 may manufacture the brush in-store, while they wait.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A method of manufacturing a custom cosmetic brush, comprising the steps of:
obtaining at least one image of eyelashes of a user;
determining at least one parameter of the eyelashes from the at least one image; and
producing a cosmetic brush in dependence upon the at least one parameter.

2. The method according to claim 1, wherein:
the cosmetic brush is a twisted wire brush having a core wire section and a plurality of fiber bristles retained in the core wire section.

3. The method according to claim 1, wherein:
the cosmetic brush is a stacked-disc brush having a core section and a plurality of discs received on the core section.

4. The method according to claim 2, wherein:
the step of producing the cosmetic brush includes cutting or shaping bristles of the cosmetic brush in dependence upon the at least one parameter.

5. The method according to claim 4, wherein:
cutting or shaping the bristles of the cosmetic brush is carried out using a laser.

6. The method according to claim 2, wherein:
the step of producing the cosmetic brush includes shaping or deforming the core wire section.

7. The method according to claim 1, wherein:
the at least one image is at least four images, including a first image from a side of the eyelashes, a second image from the front of the eyelashes, a third image from above the eyelashes, and a fourth image from below the eyelashes.

8. The method according to claim 1, wherein:
the images are obtained using a smartphone.

9. The method according to claim 1, wherein:
the at least one parameter is at least one of a number of eyelashes, an eyelash spacing, an eyelash length, and/or an eyelash angle.

10. The method according to claim 1, further comprising the step of:
generating a prompt for user-selection of a mascara function, the function including at least lengthening, volume, natural look, and separation.

11. The method according to claim 1, further comprising the step of:
generating a prompt for a user to take the at least one image utilizing a digital imaging device.

12. A system for creating a custom cosmetic brush, comprising:
a digital imaging device configured to capture an image of eyelashes of a user; and
an image analysis module configured to determine at least one parameter of the eyelashes from the image.

13. The system of claim 12, wherein:
the at least one parameter includes at least a number of eyelashes, an eyelash spacing, an eyelash length, and/or an eyelash angle.

14. The system of claim 12, wherein:
the digital imaging device is a smartphone or tablet.

15. The system of claim 12, further comprising:
a manufacturing system configured to produce a cosmetic brush in dependence upon the at least one parameter.

16. The system of claim 15, wherein:
the manufacturing system is configured to cut bristles of the cosmetic brush in dependence upon the at least one parameter and/or shape or deform a core section of the cosmetic brush in dependence upon the at least one parameter.

17. The system of claim 12, wherein:
the image analysis module is embedded in software running on the digital imaging device.

18. A method for customizing a cosmetic product, comprising the steps of:
generating a prompt to capture an image of eyelashes of a user;
receiving a captured image of the eyelashes;
determining eyelash parameter data from the captured image; and
presenting a cosmetic brush recommendation to a user, or manufacturing a cosmetic brush in dependence upon the eyelash parameter data.

19. The method according to claim 18, wherein:
the eyelash parameter data includes at least a number of eyelashes, an eyelash spacing, an eyelash length, and/or an eyelash angle.

20. The method according to claim 18, further comprising the steps of:
generating a prompt for user-selection of a cosmetic product function, the cosmetic product function including at least lengthening, volume, natural look, and separation of eyelashes.
